(19) United States
(12) Patent Application Publication
(10) Pub. No.: US 2026/0093606 A1
(43) Pub. Date: Apr. 2, 2026

(54) SYSTEM AND METHOD FOR INCORPORATING USER FEEDBACK IN A LARGE LANGUAGE MODEL-BASED RETRIEVAL AUGMENTATION TOOL

(71) Applicant: GM Global Technology Operations LLC, Detroit, MI (US)

(72) Inventors: Arun Adiththan, Sterling Heights, MI (US); Ramesh Sethu, Troy, MI (US); Prakash M. Peranandam, Rochester Hills, MI (US); Azeem Sarwar, Rochester Hills, MI (US); Howard J. Carver, Troy, MI (US); Syed Shihab Ullah, Shelby Township, MI (US); Aruna I. Paul, Ann Arbor, MI (US); Jacob Betz, Farmington Hills, MI (US); Robert Michael Wojno, Newtown, PA (US)

(21) Appl. No.: 18/901,121

(22) Filed: Sep. 30, 2024

(51) Int. Cl. G06F 11/36; G06F 11/34; G06N 5/022

(52) U.S. Cl. CPC G06F 11/3672; G06F 11/3409; G06N 5/022

(57) ABSTRACT

A system for incorporating user feedback in a large language model (LLM) based retrieval augmentation (RAG) tools includes an application for incorporating user feedback (UFA). The UFA receives an input to the LLM from a host device user, generates an LLM output as a response to the input, causes a system user to verify the LLM output and provide user feedback via a human-machine interface (HMI) of the host device, and in response to the user feedback, engages a performance tuning optimizer that modifies the LLM output by: revising domain knowledge, revising system prompts, and performing constrained regeneration of the LLM output. The performance tuning optimizer progressively reduces computational resource utilization, progressively increases computational efficiency, and progressively reduces reliance on human validators and user feedback over time, and wherein the LLM output is a command to one or more systems of the host device.

The present disclosure relates to systems and methods for generating validation test suites for artificial intelligence powered tools, and more specifically to automatic generation of validation and evaluation test suites for large language model powered tools. Artificial intelligence (AI) models, including large language models (LLMs) are increasingly being used to perform tasks for end users in a variety of technical and non technical pursuits. Outputs of AI models, including LLMs, can be hampered by lack of systematic coverage metrics, non-diversified test sets and uneven test coverages and coverage measurements. Accordingly, LLMs are trained on vast quantities of data, often from a variety of sources, and then retrieval-augmented generation (RAG) processes are used to optimize the outputs of the LLMs to ensure accuracy. However, even RAG-assisted LLMs can generate outputs that are inaccurate, inappropriate, or otherwise compromised for a variety of reasons.

Accordingly, while current systems and methods for validation of generative AI powered tools achieve their intended purpose, there is a need for a new and improved system and method that provides a systematic approach to automatically determine accuracy, relevancy, and consistency of RAG tool assisted LLMs that ensure LLM output accuracy, precision, consistency, reliability, and which provide redundant and consistent checks to ensure the LLM output accuracy, precision, consistency and reliability are maintained while maintaining or reducing system complexity, and providing for user feedback to further ensure the accuracy, relevancy, and consistency of LLM outputs.

### SUMMARY

According to several aspects, a system for incorporating user feedback in a large language model (LLM) based retrieval augmentation (RAG) tools includes a host device having a controller. The controller has a processor, a memory, and input/output (I/O) ports. The I/O ports are in communication with a human-machine interface (HMI) and one or more databases. The processor executes programmatic control logic stored in the memory. The programmatic control logic includes an application for incorporating user feedback (UFA) in LLM based RAG tools. The UFA includes at least first, second, third, and fourth control logics. The first control logic receives an input to the LLM from a host device user. The second control logic generates an LLM output as a response to the input. The third control logic causes a system user to verify the LLM output and provide user feedback via a human-machine interface (HMI) of the host device. The fourth control logic, in response to the user feedback, engages a performance tuning optimizer that modifies the LLM output by: revising domain knowledge, revising system prompts, and performing constrained regeneration of the LLM output. The performance tuning optimizer progressively reduces computational resource utilization, progressively increases computational efficiency, and progressively reduces reliance on human validators and user feedback over time, and wherein the LLM output is a command to one or more systems of the host device.

In another aspect of the present disclosure the first control logic further includes control logic for receiving the input via the human-machine interface (HMI) of the host device.

In another aspect of the present disclosure the second control logic further includes control logic for engaging an ensemble retriever. The ensemble retriever determines a similarity between the input and predetermined data in the one or more databases stored in the memory. The second control logic further includes control logic for causing the ensemble retriever to generate the LLM output and an output confidence score, control logic for causing a human validator to prioritize and review the LLM output in accordance with the output confidence score, and control logic for assigning the output confidence score to the LLM output. The LLM output commands one or more actuators of the host device to adjust performance of relevant host device systems. The second control logic further includes control logic that causes the human validator to prioritize and review the LLM output according to the output confidence score and a ranked context, and control logic that causes the human validator to selectively update one or more of a text vector database and a raw text database with data obtained from the input, the LLM output, and the output confidence score. The host device is a vehicle and LLM output commands to the one or more actuators of the vehicle alter functionality of the vehicle in accordance with inputs received from the user.

In another aspect of the present disclosure the third control logic further includes control logic that prompts the system user for feedback via a request for confirmation that the LLM output is a sufficiently accurate response to the input or user command. The request for confirmation further comprises: an audiovisual, tactile, verbal, numerical, or alphanumeric request for confirmation, and the sufficiently accurate response is gauged based upon personal preference of the user.

In another aspect of the present disclosure the fourth control logic further includes control logic for engaging a subroutine for revising domain knowledge (SRDK). The SRDK receives the LLM output and the user feedback and determines whether the LLM output has been modified by the user and upon determining that the LLM output has been modified by the user, executes control logic for optimizing a domain knowledge base (DKB).

In another aspect of the present disclosure the control logic for optimizing the DKB further includes control logic that retrieves the confidence score of the LLM output that has been modified by the user, and determines whether the LLM output that has been modified by the user is already present in the DKB. Upon determining that the LLM output that has been modified by the user is not already present in the DKB, the control logic for optimizing the DKB obtains input from human experts to verify that the LLM output that has been modified by the user correctly added to the DKB. Upon determining that the LLM output that has been modified by the user is already present in the DKB, the control logic for optimizing the DKB revises domain knowledge embedded in the DKB, thereby generating an updated DKB containing the LLM output that has been modified by the user.

In another aspect of the present disclosure the fourth control logic further includes control logic for engaging a subroutine for revising system prompts (SRSP). The SRSP receives a prompt revision verification request, the LLM output, and the user feedback and determines whether sufficient evidence exists to implement revisions to system prompts. In order to determine whether sufficient evidence exists, the SRSP compares a host device prompt to the user feedback and determines whether a threshold level of similarity exists between the host device prompt and the user feedback. Upon determining that sufficient evidence does exist, the fourth control logic executes control logic to rewrite the system prompt, subject to performance testing.

In another aspect of the present disclosure the control logic to rewrite the system prompt further includes control logic that performs regression testing on a rewritten system prompt. The regression testing utilizes test inputs stored in memory of the DKB. The regression testing verifies that new information in rewritten system prompts allows the system to continue functioning without negatively impacting system responses. Upon determining that the rewritten system prompt is functioning properly, the system executes control logic that updates the system prompt in the DKB. Upon determining that the rewritten system prompt is not functioning properly, the system continues utilizing user feedback to recursively and continuously rewrite the system prompt, regression test the rewritten system prompt and test for system functionality until the regression testing indicates that the new information allows the system to continue functioning without negatively impacting system responses.

In another aspect of the present disclosure the fourth control logic further includes control logic for executing a subroutine for constrained regeneration (SCR). The SCR utilizes user feedback in response to LLM outputs to revise LLM outputs based on user constraints.

In another aspect of the present disclosure the SCR further includes control logic for reviewing context used by the LLM to generate the LLM output, and control logic for determining whether low quality context is present. Low quality contexts define low-quality matches between the context used by the LLM to generate the LLM output and a context of the user input. Low quality contexts are defined according to user preferences. The SCR further includes control logic that receives user feedback via the HMI indicating that a low-quality context is present, removing the low quality context, and reprioritizing contexts before executing control logic to regenerate an LLM output subject to user feedback constrained context.

In another aspect of the present disclosure a method for incorporating user feedback in a large language model (LLM) based retrieval augmentation (RAG) tools includes executing, by a processor of a controller of a vehicle, programmatic control logic stored within memory of the controller. The controller further having input/output (I/O) ports, the I/O ports in communication with a human-machine interface (HMI) and one or more databases. The programmatic control logic including an application for incorporating user feedback (UFA) in LLM based RAG tools. The UFA includes control logic for receiving an input to the LLM from a vehicle user, via the HMI of the vehicle, generating an LLM output as a response to the input, causing a user to verify the LLM output and provide user feedback via a human-machine interface (HMI) of vehicle; and in response to the user feedback, engaging a performance tuning optimizer that modifies the LLM output by: revising domain knowledge, revising system prompts, and performing constrained regeneration of the LLM output. The performance tuning optimizer progressively reduces computational resource utilization, progressively increases computational efficiency, and progressively reduces reliance on human validators and user feedback over time, and wherein the LLM output is a command to one or more systems of the vehicle.

In another aspect of the present disclosure the method further includes engaging an ensemble retriever. The ensemble retriever determines a similarity between the input and predetermined data in the one or more databases stored in the memory, and causing the ensemble retriever to generate the LLM output and an output confidence score. The method further includes causing a human validator to prioritize and review the LLM output in accordance with the output confidence score, and assigning the output confidence score to the LLM output. The LLM output commands one or more actuators of the vehicle to adjust performance of relevant vehicle systems. The method further includes causing the human validator to prioritize and review the LLM output according to the output confidence score and a ranked context; and causing the human validator to selectively update one or more of a text vector database and a raw text database with data obtained from the input, the LLM output, and the output confidence score. LLM output commands to the one or more actuators of the vehicle alter functionality of the vehicle in accordance with inputs received from the user.

In another aspect of the present disclosure the method further includes prompting the user for feedback via a request for confirmation that the LLM output is a sufficiently accurate response to the input or user command. The request for confirmation further includes: an audiovisual, tactile, verbal, numerical, or alphanumeric request for confirmation, and the sufficiently accurate response is gauged based upon personal preference of the user.

In another aspect of the present disclosure the method further includes engaging a subroutine for revising domain knowledge (SRDK). The SRDK receives the LLM output and the user feedback and determines whether the LLM output has been modified by the user and upon determining that the LLM output has been modified by the user, executes control logic for optimizing a domain knowledge base (DKB).

In another aspect of the present disclosure optimizing the DKB further includes retrieving the confidence score of the LLM output that has been modified by the user, and determining whether the LLM output that has been modified by the user is already present in the DKB. Upon determining that the LLM output that has been modified by the user is not already present in the DKB, the method obtains input from human experts to verify that the LLM output that has been modified by the user correctly added to the DKB. Upon determining that the LLM output that has been modified by the user is already present in the DKB, the method revises domain knowledge embedded in the DKB, thereby generating an updated DKB containing the LLM output that has been modified by the user.

In another aspect of the present disclosure the method further includes engaging a subroutine for revising system prompts (SRSP). The SRSP receives a prompt revision verification request, the LLM output, and the user feedback and determines whether sufficient evidence exists to implement revisions to system prompts. The SRSP further includes determining whether sufficient evidence exists by comparing, with the SRSP, a vehicle prompt to the user feedback; and determining whether a threshold level of similarity exists between the vehicle prompt and the user feedback. Upon determining that sufficient evidence does exist, the method rewrites the system prompt, subject to performance testing.

In another aspect of the present disclosure rewriting the system prompt further includes performing regression testing on a rewritten system prompt. The regression testing utilizes test inputs stored in memory of the DKB. The regression testing verifies that new information in rewritten system prompts allow the vehicle to continue functioning without negatively impacting vehicle responses. Upon determining that the rewritten system prompt is functioning properly, the regression testing executes control logic that updates the system prompt in the DKB. Upon determining that the rewritten system prompt is not functioning properly, the regression testing continues utilizing user feedback to recursively and continuously rewrite the system prompt, regression test the rewritten system prompt and test for vehicle functionality until the regression testing indicates that the new information allows the vehicle to continue functioning without negatively impacting system responses.

In another aspect of the present disclosure the method further includes executing a subroutine for constrained regeneration (SCR). The SCR utilizes user feedback in response to LLM outputs to revise LLM outputs based on user constraints.

In another aspect of the present disclosure the SCR further includes control logic for: reviewing context used by the LLM to generate the LLM output, and determining whether low quality context is present. Low quality contexts define low-quality matches between the context used by the LLM to generate the LLM output and a context of the user input. Low quality contexts are defined according to user preferences. The SCR further includes control logic for receiving user feedback via the HMI indicating that a low-quality context is present, removing the low quality context, and reprioritizing contexts before executing control logic to regenerate an LLM output subject to user feedback constrained context.

In another aspect of the present disclosure a method for incorporating user feedback in a large language model (LLM) based retrieval augmentation (RAG) tools includes: executing, by a processor of a controller of a vehicle, programmatic control logic stored within memory of the controller. The controller further includes input/output (I/O) ports in communication with a human-machine interface (HMI) and one or more databases. The programmatic control logic includes an application for incorporating user feedback (UFA) in LLM based RAG tools including control logic for: receiving an input to the LLM from a vehicle user, via the HMI of the vehicle, generating an LLM output as a response to the input, including: engaging an ensemble retriever. The ensemble retriever determines a similarity between the input and predetermined data in the one or more databases stored in the memory. The method further includes control logic for causing the ensemble retriever to generate the LLM output and an output confidence score, causing a human validator to prioritize and review the LLM output in accordance with the output confidence score; and assigning the output confidence score to the LLM output. The LLM output commands one or more actuators of the vehicle to adjust performance of relevant vehicle systems. The method further includes control logic for causing the human validator to prioritize and review the LLM output according to the output confidence score and a ranked context, and causing the human validator to selectively update one or more of a text vector database and a raw text database with data obtained from the input, the LLM output, and the output confidence score. The LLM output commands to the one or more actuators of the vehicle alter functionality of the vehicle in accordance with inputs received from the user. The method further includes control logic for causing a user to verify the LLM output and prompting the user for feedback via the HMI of the vehicle, including providing a request for confirmation that the LLM output is a sufficiently accurate response to the input or user command. The request for confirmation further comprises: an audiovisual, tactile, verbal, numerical, or alphanumeric request for confirmation, and wherein the sufficiently accurate response is gauged based upon personal preference of the user. In response to the user feedback, engaging a performance tuning optimizer that modifies the LLM output by: revising domain knowledge including: engaging a subroutine for revising domain knowledge (SRDK). The SRDK receives the LLM output and the user feedback and determines whether the LLM output has been modified by the user and upon determining that the LLM output has been modified by the user, executes control logic for optimizing a domain knowledge base (DKB). The method further includes control logic for retrieving the confidence score of the LLM output that has been modified by the user, and determines whether the LLM output that has been modified by the user is already present in the DKB. Upon determining that the LLM output that has been modified by the user is not already present in the DKB, the method executes control logic for obtaining input from human experts to verify that the LLM output that has been modified by the user correctly added to the DKB, and upon determining that the LLM output that has been modified by the user is already present in the DKB, revising domain knowledge embedded in the DKB, thereby generating an updated DKB containing the LLM output that has been modified by the user. The method further includes control logic for revising system prompts, including: engaging a subroutine for revising system prompts (SRSP). The SRSP receives a prompt revision verification request, the LLM output, and the user feedback and determines whether sufficient evidence exists to implement revisions to system prompts. The method further includes control logic for determining whether sufficient evidence exists by comparing, with the SRSP a vehicle prompt to the user feedback; and determining whether a threshold level of similarity exists between the vehicle prompt and the user feedback. Upon determining that sufficient evidence does exist, the method executes control logic for rewriting the system prompt, subject to performance testing, and performing regression testing on a rewritten system prompt. The regression testing utilizes test inputs stored in memory of the DKB. The regression testing verifies that new information in rewritten system prompts allow the vehicle to continue functioning without negatively impacting vehicle responses. Upon determining that the rewritten system prompt is functioning properly, the method executes control logic that updates the system prompt in the DKB. Upon determining that the rewritten system prompt is not functioning properly, the method continues utilizing user feedback to recursively and continuously rewrite the system prompt, regression test the rewritten system prompt and test for vehicle functionality until the regression testing indicates that the new information allows the vehicle to continue functioning without negatively impacting system responses. The method further includes control logic for performing constrained regeneration of the LLM output, including: executing a subroutine for constrained regeneration (SCR). The SCR utilizes user feedback in response to LLM outputs to revise LLM outputs based on user constraints, reviewing context used by the LLM to generate the LLM output, and determining whether low quality context is present. Low quality contexts define low-quality matches between the context used by the LLM to generate the LLM output and a context of the user input. Low quality contexts are defined according to user preferences. The method further includes control logic for receiving user feedback via the HMI indicating that a low-quality context is present, removing the low quality context, and reprioritizing contexts before executing control logic to regenerate an LLM output subject to user feedback constrained context. The performance tuning optimizer progressively reduces computational resource utilization, progressively increases computational efficiency, and progressively reduces reliance on human validators and user feedback over time, and wherein the LLM output is a command to one or more systems of the vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram depicting a system for computing confidence scores for large language model (LLM) based retrieval augmentation (RAG) tools according to an exemplary embodiment;

FIG. 2 is a flowchart depicting logical flow of an application of the system for computing confidence scores for LLM based RAG tools of FIG. 1 according to an exemplary embodiment;

FIG. 3 is a flowchart depicting logical flow of an application for incorporating user feedback (UFA) of the system of FIG. 1 according to an exemplary embodiment;

FIG. 4 is a flowchart depicting logical flow of a subroutine for revising domain knowledge (SRDK) within the UFA of FIG. 3 according to an exemplary embodiment;

FIG. 5 is a flowchart depicting logical flow of a subroutine for revising system prompts (SRSP) within the UFA of FIG. 3 according to an exemplary embodiment; and

FIG. 6 is a flowchart depicting logical flow of a subroutine for constrained regeneration (SCR) within the UFA of FIG. 3 according to an exemplary embodiment.

### DETAILED DESCRIPTION

The following description is merely exemplary in nature and is not intended to limit the present disclosure, application, or uses.

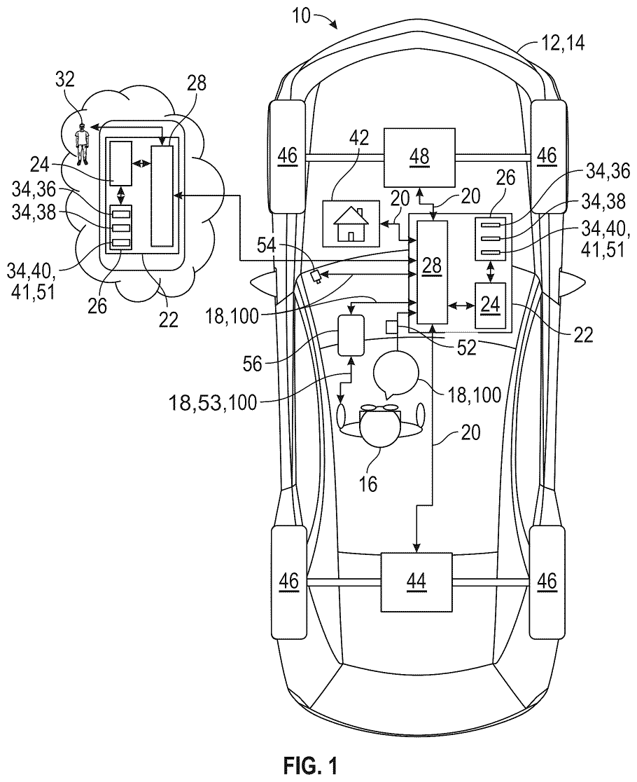

Referring to FIG. 1, a system 10 for computing confidence scores for large language model (LLM) based retrieval augmentation (RAG) tools is shown in schematic form. The system 10 generally functions in or on a host device 12. The host device 12 may take any of a wide variety of forms, including a vehicle 14. However, it should be appreciated that the system 10 of the present disclosure need not be tied to such a vehicle 14. Rather, the vehicle 14 is merely an exemplary non-limiting embodiment in relation to which the system 10 of the present disclosure is described herein. The system 10 may operate in any hardware and software configuration in which a generative AI powered tool is used to receive inputs from a user 16, such as user commands 18, and generate an output 20 that alters the function of the hardware and/or software configuration or system in which the generative AI powered tool is being used. Additionally, while the vehicle 14 shown is a car, it should be appreciated that the vehicle 14 may be any type of vehicle 14 without departing from the scope or intent of the present disclosure. In several non-limiting examples, the vehicle 14 may be a: car, truck, sport utility vehicle (SUV), semi truck, tractor trailer, tractor, combine harvester or other such farming equipment, powered flight and unpowered aircraft such as a plane, helicopter, glider or autogyro, powered and unpowered watercraft such as: a ship, sailboat, motorboat, pleasurecraft, jet ski, sailboat, or the like. In additional non-limiting embodiments, it should be appreciated that the system 10 described herein may be adapted to function with host devices 12 such as manned and unmanned spacecraft such as: satellites, rockets, space stations, and other orbital and extra-orbital satellite-communications-enabled devices without departing from the scope or intent of the present disclosure. In still further non-limiting examples, the host devices 12 may include mobile computing platforms such as laptops, mobile phones, tablets, or any other such host device 12 through which a user may engage with a generative AI powered tool.

The system 10 further includes a controller 22 which is a non-generalized, electronic control device having a preprogrammed digital computer or processor 24, non-transitory computer readable medium or memory 26 used to store data such as control logic, software applications, instructions, computer code, data, lookup tables, etc., and a transceiver or input/output (I/O) ports 28. Computer readable medium or memory 26 includes any type of medium capable of being accessed by a computer, such as read only memory (ROM), random access memory (RAM), a hard disk drive, a compact disc (CD), a digital video disc (DVD), or any other type of memory 26. A “non-transitory” computer readable memory 26 excludes wired, wireless, optical, or other communication links that transport transitory electrical or other signals. A non-transitory computer readable memory 26 includes media where data can be permanently stored and media where data can be stored and later overwritten, such as a rewritable optical disc or an erasable memory device. Computer code includes any type of program code, including source code, object code, and executable code. The processor 24 is configured to execute the code or instructions.

Where the system 10 operates on a vehicle 14, the controller 22 may include a dedicated Wi-Fi controller or an engine control module, a transmission control module, a body control module, an infotainment control module, etc. The transceiver or I/O ports 28 are configured to wirelessly communicate with a back office 30 using cellular protocols including global system for mobile communication (GSM), general packet radio service (GPRS), enhanced data rates for GSM evolution (EDGE), universal mobile telecommunications services (UMTS), high speed packet access (HSPA), code-division multiple access (CDMA), evolution-data optimized (EV-DO/EVDO/1×EV-DO), short message services (SMS), Wi-MAX, manufacturing messages specification (MMS), 2G, 3G, 4G, 5G, wireless and cellular standards as defined under IEEE 802.1X, IEEE 802 LAN/MAN, and IEEE mobile communication networks standards committee (MobiNet-SC) standards, and the like. The back office 30 may include one or more controllers 22 and/or one or more human experts or validators 32 shown and described in additional detail in subsequent figures.

The controller 22 further includes one or more applications 34. An application 34 is a software program configured to perform a specific function or set of functions. The application 34 may include one or more computer programs, software components, sets of instructions, procedures, functions, objects, classes, instances, related data, or a portion thereof adapted for implementation in a suitable computer readable program code. The applications 34 may be stored within the memory 26 or in additional or separate memory. Examples of the applications 34 include audio or video streaming services, games, browsers, social media, etc., an algorithm that computes confidence scores for large language model (LLM) 36 based RAG tools 38 (hereinafter CLR application 40) for a generative AI powered tool or LLM 36 tool, and an application 34 for incorporating user feedback (hereinafter UFA 41). The generative AI powered tool or LLM 36 defines an application 34 stored either locally on the vehicle 14 controller 22 and/or in a remote back office 30 or cloud-based computing device. The CLR application 40 includes a plurality of subroutines or control logic portions.

In examples in which the system 10 operates in or on a vehicle 14, the system 10 and CLR application 40 may be used by the vehicle operator or a vehicle development engineering user 16 to validate the tools used to develop and test systems that dynamically adjust the way that the vehicle 14 and vehicle 14 features are operated. In some examples, the vehicle 14 may be equipped with a navigation system 42, one or more drive motors 44 that provide and alter quantities of torque delivered to wheels 46 of the vehicle 14 to cause the vehicle 14 to move, stop, or the like, and a steering system 48 that may adjust a directional heading of the vehicle 14. In additional examples, the vehicle 14 is equipped with a braking system 50 that, when engaged by the controller 22 causes the motion of the vehicle 14 to be retarded. The vehicle 14 may be equipped with a variety of other body motion control systems that may be engaged to alter, or otherwise control dynamic performance of the vehicle 14, including but not limited to aerodynamic control surfaces and actuators, active and/or semi-active suspension systems and actuators, and the like without departing from the scope or intent of the present disclosure.

LLMs 36 are trained on vast quantities of data in one or more of online and offline modes. The training data provides a way for the LLMs 36 to effectively generate outputs for tasks such as answering questions, performing mathematical calculations, performing language translation and/or summarization. Retrieval augmented generation (RAG) is an architectural approach for improving quality of LLM 36 generated responses by grounding the LLM 36 model on external sources of knowledge to supplement the LLM's 36 internal representation of information. Implementing RAG in an LLM 36 based question answering system has at least two main benefits: ensuring that the LLM 36 has access to the most current, reliable data, and that users 16 have access to the LLM's 36 sources, ensuring that the LLM's 36 responses to user 16 inputs may be trusted. Additionally, RAG grounds the LLM 36 on a set of external, verifiable facts, resulting in an LLM 36 that has few opportunities to pull information baked into its parameters, thereby reducing the chances that the LLM 36 will leak sensitive data or provide incorrect or misleading responses to user 16 inputs. More specifically, the LLM 36 based RAG tools 38 of the present disclosure extend the capabilities of and improves the efficiency of LLM 36 applications by leveraging customized data. The customized data may relate to any of a wide range of topics, but should generally be understood to relate specifically to particular hardware or software applications of the host device 12. In a non-limiting example, the customized or domain-specific knowledge data stored in a domain knowledge base (DKB) 51, may relate to onboard systems of a vehicle 14, including but not limited to navigation systems, powertrain control systems, suspension control systems, heating ventilation and air conditioning (HVAC) systems, and the like. The LLMs 36 utilize RAG tool 38 customized data relevant to a user 16 generated command, question or task and provide the customized data as context for the LLM 36 to generate a response. In many respects, RAG is an effective approach to improve LLM 36 performance and is successful in supporting chatbots and question and answer (Q & A) systems that require access to domain-specific information. Domain-specific information may include any of a wide range of data relating to the particular host device 12, vehicle 14, and back office 30 functions, and relating additionally to the onboard hardware, software, and applications for each of the host device 12, vehicle 14, and back office 30. Domain-specific information may also relate to specific proprietary data held by an original equipment manufacturer (OEM), relating to the specific hardware and software products manufactured by the OEM. The domain-specific information may define an embedded model stored within memory 26 of the controller 22 onboard the host device 12.

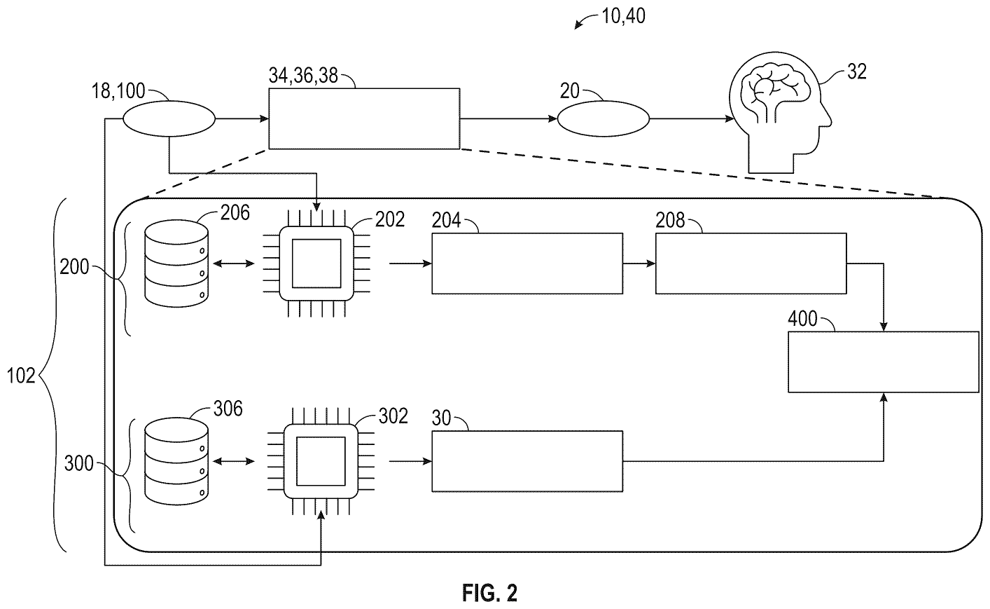

Referring now to FIG. 2 and with continuing reference to FIG. 1, an exemplary schematic logical flow diagram of the CLR application 40 is shown in additional detail. The CLR application 40 receives an input 100 in an offline mode. The input 100 may be received via a host device 12 human-machine interface (HMI) 53, including but not limited to an audio or visual or audiovisual receiver such as a microphone or other audio sensor 52, a camera or other vision sensor 54, tactile interfaces including but not limited to buttons and touchscreens 56, or the like. In several examples, the input 100 is a user 16 command 18, which is subsequently processed through the LLM 36 based RAG tool 38 in a series of subroutines before generating the output 20. The input 100 may take any of a wide variety of forms without departing from the scope or intent of the present disclosure. In some non-limiting examples, the input 100 may include verbal or written user commands 18 in any language, such as: commands to engage the vehicle 14 navigation system, commands to search for a point of interest, commands to change a vehicle 14 cabin temperature, commands to pause or wait or delay, requests to obtain a solution to a mathematical statement, or any other such commands 18. The input 100 is processed through a plurality of subroutines within the LLM 36 based RAG tool 38.

The output 20 is a host device 12 response to the input 100 from the user 16. In several aspects, the output 20 directly or indirectly alters the function of one or more systems of the host device 12, including but not limited to: altering one or more functions of the navigation system, powertrain control system, suspension control system, HVAC system, or the like. The output 20, may thus include an LLM output command that changes a navigation system destination or route planning functionality, changes a powertrain, suspension control, or HVAC system mode or operation by directly or indirectly altering positions of actuators of the host device within relevant host device 12 systems to adjust the performance of the relevant system in response to the user 16 command 18 input 100.

The RAG tool 38 includes an ensemble retriever 102. Ensemble retrievers 102 are sophisticated retrieval algorithms that improve relevancy of retrieved context information by pooling results from multiple distinct and parallel retrievers. Through the use of multiple parallel retrievers, strengths of each of the multiple parallel retrievers may be leveraged to more accurately fetch results relating to the user command 18 or input 100 than individual data retriever algorithms might individually. The input 100 is received within the ensemble retriever 102 by at least two parallel subroutines of the LLM 36 based RAG tool 38, namely a semantic tool 200 and a syntactic tool 300. The semantic tool 200 receives the input 100 in a semantic retriever 202. The semantic retriever 202 subroutine first extracts semantic information from the input 100. The semantic retriever 202 then calculates a semantic similarity score 204 for the semantic information extracted from the input 100. To calculate the semantic similarity score 204, the semantic retriever 202 converts the extracted semantic information from the input 100 into a semantic text vector in vector space such that the vector is a mathematical, graphical representation of the extracted semantic information from the input 100. As used herein, the meaning of any particular semantic vector is implicitly defined by the position and direction in vector space. In a non-limiting example, the input 100 may include a verbal command from a user 16. It should be appreciated that the verbal command may be any of a wide variety of different commands, including but not limited to: “increase cabin temperature”, with the user 16 intending that the input 100 command cause the vehicle 14 to utilize a heating, ventilation and air-conditioning (HVAC) system to alter a temperature of the vehicle 14 passenger compartment. Each word, i.e. “increase,” “cabin”, and “temperature”, in the user 16 input 100 command is parsed and plotted in vector space and subsequently compared to predetermined text vectors in a text vector database 206 stored in memory 26.

Because individual user 16 language input 100 commands may differ in actual diction or verbiage chosen, the vector representing the input 100 may not be precisely represented by text vectors stored in the text vector database 206. The text vector database 206 contains a plurality of semantic text vectors defining mathematical, graphical, vectorized representations of predefined semantic inputs 100 that the host device 12 is programmed to accept, respond to, and understand. The plurality of text vectors in the text vector database 206 may be manually and/or automatically chosen during pre-production programming of the system 10, and the plurality of text vectors may be updated with new information upon the occurrence of a particular event, or may be updated or modified manually or automatically, constantly, periodically, or the like. In non-limiting examples, the text vector database 206 is updated by the human experts or validators 32.

Accordingly, the semantic retriever 202 calculates the semantic similarity score 204 based on the text vector representing the input 100 and predefined text vector information accessed within the text vector database 206. In several aspects, the semantic similarity score 204 is a numerical, graphical, vectorized representation of a level of similarity between the semantic structure of the input 100 and the semantic structure of the of the text vectors corresponding most closely to the semantic text vector of the input 100. After calculating the semantic similarity score 204, the semantic tool 200 performs a rank fusion calculation 208 that filters the input 100 context based on a threshold T to avoid “low quality” contexts or low-quality matches between the data in the text vector database 206 and the text vector representing the input data 100. More specifically, the CLR application 40 utilizes a reciprocal rank fusion algorithm to re-rank and merge results from each of the semantic tool 200 and syntactic tool 300.

That is, the ensemble retriever 102 (Retᵢ) obtains a retrieved context Cᵢ₁, and vector similarity score, Sᵢ₁, and eliminates context Cᵢ if and only if the similarity score of Cᵢ is such that the vector similarity score Sᵢ is less than the threshold T. By contrast, “high quality” contexts are defined based on an importance score where importance weight is calculated based on a count of context, Cᵢ, in different retrievers, CCᵢ, a rank of a context, Cᵢ, in different retrievers, RCᵢ, and an importance score of a context, Cᵢ, is given as, ICᵢ=f(CCᵢ, RCᵢ). The contexts are then ranked based on the importance score ICᵢ. Thus, in some non-limiting examples, a series of ranked semantic similarity scores are generated according to:

$${Ret}_{a} = [ ( {C}_{a 1} , {S}_{a 1} ) , ( {C}_{a 2} , {S}_{a 2} ) , … ( {C}_{an} , {S}_{an} ) ]$$

$${Ret}_{b} = [ ( {C}_{b 1} , {S}_{b 1} ) , ( {C}_{b 2} , {S}_{b 2} ) , … ( {C}_{bn} , {S}_{bn} ) ]$$

$${Ret}_{c} = [ ( {C}_{c 1} , {S}_{c 1} ) , ( {C}_{c 2} , {S}_{c 2} ) , … ( {C}_{cn} , {S}_{cn} ) ]$$

where, context {Cᵢⱼ}, j≥1 is ranked based on similarity score, i.e.: Sᵢ₁>Sᵢ₂ . . . >Sᵢₙ. The importance score ICᵢ defines a relative importance of the context Cᵢ in relation to the type of input 100 received. Thus, in a non-limiting example, the importance score ICᵢ has a low value for contexts Cᵢ, such as HVAC functions, that do not implicate critical host device 12 functions, such as powertrain, suspension or safety critical systems of a vehicle 14. By contrast, the importance score ICᵢ is higher than the low value when the context Cᵢ indicates that the input 100 is more closely related to or directly implicates critical host device 12 functions.

By contrast, the syntactic tool 300, which operates in parallel with the semantic tool 200, receives the input 100 within a syntactic retriever 302. The syntactic retriever 302 subroutine, like the semantic retriever 202 subroutine, first extracts syntactic information from the input 100. The syntactic retriever 302 subroutine then calculates a syntactic similarity score 304 based on the raw text of the input 100 and a raw text database 306 stored in memory 26. The raw text database 306 contains a plurality of plurality of raw text vectors defining mathematical, graphical, vectorized representations of predefined syntactic inputs 100 that the host device 12 is programmed to accept and understand. The plurality of raw text vectors in the raw text database 306 may be manually and/or automatically chosen during pre-production programming of the system 10, and the plurality of raw text vectors may be updated with new information upon the occurrence of a particular event, or may be updated or modified manually or automatically, constantly, periodically, or the like. As used herein, the meaning of any particular raw text vector is implicitly defined by the position and direction in vector space. In non-limiting examples, the raw text database 306 is updated by the human experts or validators 32.

To calculate the syntactic similarity score 304, the syntactic retriever 302 subroutine converts the extracted syntactic information from the input 100 into a raw text vector in vector space such that the vector is a mathematical, graphical representation of the extracted syntactic information from the input 100. The syntactic similarity score 304 is a numerical representation of a level of similarity between the syntactic structure of the input 100 and data in the raw text database 36. More specifically, the syntactic similarity score 304 is calculated on the basis of a Jaccard index and a Levenshtein distance between. The Jaccard index,

$$J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} ,$$

is used to gauge the similarity and diversity of the input 100 information to predefined raw text information stored in the raw text database 306. Similarly, the Levenshtein distance is a string metric used to measure a difference between two sequences, or in the present instance, a difference between the raw text of the input 100 and the raw text stored in the raw text database 306. In an example, a Levenshtein distance between two words is the minimum number of single-character edits (i.e. insertions, deletions, or substitutions) required to change one word into the other. The Levenshtein distance may be mathematically represented as follows:

$$lev ( a , b ) = \{ \begin{matrix}\vert a \vert & if \vert b \vert = 0 , \\ \vert b \vert & if \vert a \vert = 0 , \\ lev ( tail ( a ) , tail ( b ) & if head ( a ) = head ( b ) , \\ 1 + min \{ \begin{matrix}lev ( tail ( a ) , b ) \\ lev ( a , tail ( b ) ) \\ lev ( tail ( a ) , tail ( b )\end{matrix} & otherwise .\end{matrix}$$

It should be appreciated that use of the Jaccard index and Levenshtein distance are intended only as exemplary non-limiting examples of the types of algorithms or functions that may be used to compute a syntactic similarity score 304 according to the object of the present disclosure. The semantic and syntactic similarity scores 204, 304 may cover ranges of values that vary from application to application, but in one non-limiting example, the semantic and syntactic similarity scores 204, 304 are variable between values of zero (0) and one (1), such that when there is no similarity at all, the semantic and/or syntactic similarity scores 204, 304 is/are equal to zero, and when there is perfect identity between the semantic and/or syntactic similarity scores 204, 304 and information in the text vector database 206 or the raw text database 306, the values of the semantic and/or syntactic similarity scores is/are equal to one.

Subsequently, outputs of the ranked fusion calculation 208 and the syntactic similarity score 304 are combined and a confidence score 400 is calculated. The confidence score 400 is a normalized, weighted sum of the semantic similarity scores 204 and the syntactic similarity scores 304. The confidence score may be represented as:

$${C}_{out} = Z ( {w}_{i} * {Score}_{sem} + {w}_{j} * {Score}_{syn} )$$

where Z( . . . ) is the normalization function, and Wi, We are the weights. The semantic similarity score 204 is: Scoreₛₑₘ=f(rank fusion score), and the syntactic similarity score 304 is: Score_{syn}=f(Jaccard Index, Levenshtein Distance, . . . ).

In several aspects, the weights Wᵢ, Wⱼ may vary substantially from application to application. The weights Wᵢ, Wⱼ may be chosen by an application developer, an original equipment manufacturer, a supplier, or the like. It should further be appreciated that the weights Wᵢ, Wⱼ may be dynamic, variable, or constant, depending on the types of queries and the structures of the queries that the system 10 receives as inputs 100.

As described herein, LLM 36 based RAG tools 38 generate outputs 20 that, at least in pre-production processes, require verification and validation by human experts or validators 32. However, the system 10 of the present disclosure offers several advantages, including but not limited to, the automatic generation, via the CLR application 40 of the present disclosure, of output confidence score for outputs 20 of the LLM 36 such that the human experts or validators 32 may efficiently prioritize verification, thereby substantially reducing quantities of human effort and man-hours necessary to verify outputs 20 of the LLM 36, while increasing LLM 36 accuracy, reducing computational effort and computational resource consumption, and reducing the potential for human-introduced typographical, syntactical, or other such errors from a first quantity to a second quantity substantially less than the first quantity. In an example, the experts or validators 32 may choose to verify LLM 36 outputs 20 having low confidence values first, and subsequently acting to verify LLM 36 outputs 20 with confidence levels higher than the low confidence values. Accordingly, by leveraging vector-based similarity scores of a retriever and the input 100 similarity score (e.g. Jaccard distance) of a given input 100, confidence scores may be automatically computed. It will further be appreciated that in either pre-production or production guises, as the CLR 40 is continuously utilized, evaluated, and updated over time, a quantity of human expert or validator 32 interaction and input is decreased. That is, even in a production application in which a non-engineer end user or customer interacts with the LLM 36, the CLR application 40 operates to accurately, consistently, reliably, and robustly interpret end user or customer inputs to the system 10 and to generate a response accordingly, with progressively reduced computational resource utilization, progressively increased computational efficiency, and progressively reduced reliance on human validator 32 verifications.

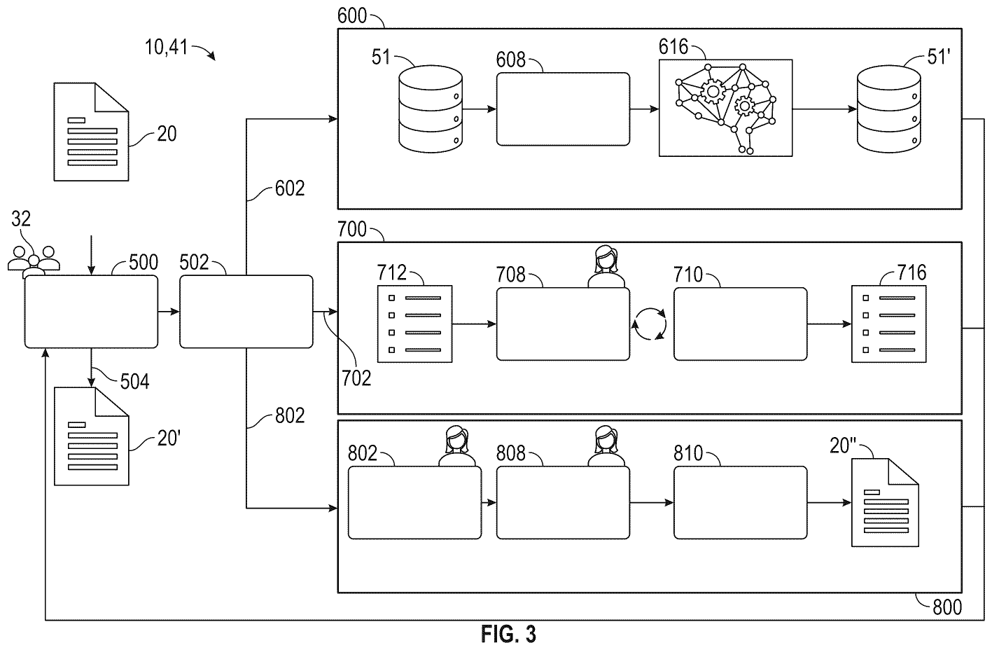

Turning now to FIG. 3 and with continuing reference to FIGS. 1 and 2, once the host device 12 or vehicle 14 is in production, the system 10, and more specifically the UFA 41 is shown in additional detail in flowchart form. Beginning at block 500, the output 20 of the LLM 36 is received by the one or more human experts or validators 32. In some examples, the human experts or validators 32 may be engineers or experts located remotely from the host device 12 or vehicle 14 in a back office 30, or the human experts or validators 32 may be host device 12 users, such as customers, or the like. Accordingly, in a non-limiting example, the human experts or validators 32 may be vehicle 14 users 16, such as a driver, passenger, or the like. The human experts or validators 32 utilize a performance tuning optimizer 502 to verify that LLM 36 outputs 20 are correct and accurate responses to the input 100 from the user 16, and to user feedback 504, such as providing correct and accurate host device 12 responses to user commands 18. That is, after utilizing the performance tuning optimizer 502 to verify the outputs 20, the UFA 41, via after receiving user feedback 504 from human experts or validators 32, generates a verified LLM output 20′. The user feedback 504 may take any of a variety of forms without departing from the scope or intent of the present disclosure. In a non-limiting example, the user feedback 504 may include one or more inputs to the HMI 53 of the host device 12, including but not limited to an audio, visual, and/or tactile user input to a microphone or other audio sensor 52, a camera or other vision sensor 54, or to tactile interfaces including but not limited to buttons and touchscreens 56, and the like. The user feedback 504 may be affirmatory and/or corrective in nature, depending on a level of similarity between the input 100 or user 16 command 18, and the LLM output 20 based thereupon.

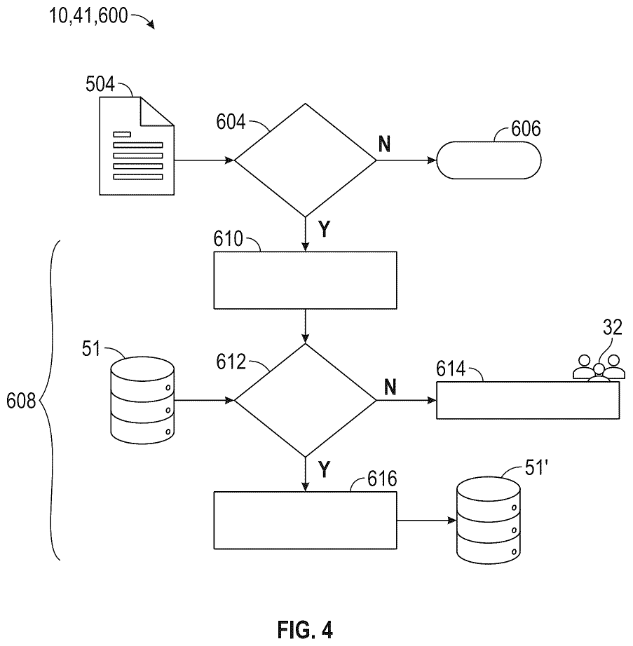

The performance tuning optimizer 502 includes at least three distinct subroutines or control logics: a subroutine for revising domain knowledge (SRDK) 600, a subroutine for revising system 10 prompts (SRSP) 700, and a subroutine for constrained regeneration (SCR) 800. Referring now to FIG. 4, and with continuing reference to FIGS. 1-3, the SRDK 600 is shown in additional detail in flowchart form.

The SRDK 600 begins by receiving a verification prompt 602 from the performance tuning optimizer 502. The verification prompt 602 includes the LLM output 20 and user 16 feedback 504. In some non-limiting examples, the verification prompt 602 is provided to the user 16 via the HMI 53. The verification prompt 602 may include an audiovisual, tactile, verbal, numerical, or alphanumeric, or other such request for confirmation that the LLM output 20 accurately and sufficiently represents the type of information or system 10 response that the user 16 intended via the input 100 or user command 18. The request for confirmation may include, but is not limited to: audiovisual, tactile, verbal, numerical, or alphanumeric request for confirmation via the HMI 53. The sufficiency of the response is gauged based upon personal preferences of the user 16. The SRDK 600 then determines at block 604 whether the output 20 from the LLM 36 has been modified by the user 16. Upon determining that the output 20 has not been modified, the SRDK 600 proceeds to block 606 where the SRDK 600 exits and results of the SRDK 600 are combined with the results from the SRSP 700 and the SCR 800 before returning to block 500 of the UFA 41. However, upon determining that the output 20 has been modified by the user 16, the SRDK 600 initiates a DKB 51 optimization process 608 that begins at block 610. At block 610 the SRDK 600 retrieves the confidence score of the user 16 modified output 20. Subsequently, at block 612, the SRDK 600 determines whether the user 16 modified output 20 is already present in the DKB 51. Upon determining that the user 16 modified output 20 is not already present in the DKB 51, the SRDK 600 proceeds to block 614 where the SRDK 600 prompts one or more human experts or validators 32 to review and provide input, responses, or other such guidance to hone the system 10 outputs to more accurately, precisely, and consistently respond to the user 16 inputs 100 or commands 18. Once the human experts or validators 32 have reviewed and provided responses that do hone the system 10 outputs 20, the SRDK 600 returns to block 612 to reassess whether the user 16 modified output 20 is present in the DKB 51. Upon determining at block 612 that the user 16 modified output 20 is present in the DKB 51, the SRDK 600 proceeds to block 616 where SRDK 600 revises knowledge embedded in the DKB 51, and an updated DKB 51′, including the new user 16 modified and expert 32 verified outputs 20.

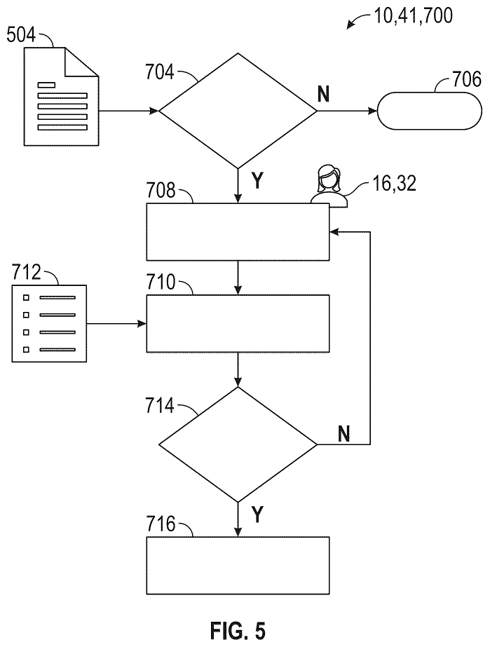

Turning now to FIG. 5 and with continuing reference to FIGS. 1-4, the SRSP 700 is shown in additional detail in flowchart form. The SRSP 700 begins by receiving a prompt revision verification request 702 from the performance tuning optimizer 502. The prompt revision verification request 702 includes the LLM output 20 and user feedback 504. The SRSP 700 then determines at block 704 whether sufficient evidence has been provided to indicate that a prompt change is appropriate. That is, at block 704, the system 10 and SRSP 700 compare the host device 12 prompt to the user feedback 504 to determine whether a threshold level of similarity exists between the host device 12 prompt and user feedback 504. Upon determining that the threshold level of similarity has been achieved, indicating that the host device 12 prompt and the user feedback 504 indicate that no changes are needed, the SRSP 700 proceeds to block 706 where the SRSP 700 exits and results of the SRSP 700 are combined with results of the SRDK 600 and the SCR 800 before returning to block 500 of the UFA 41. However, upon determining that the threshold level of similarity has not been achieved, the SRSP 700 proceeds to block 708. At block 708, the SRSP 700 rewrites the system 10 prompt. In rewriting the system 10 prompt, the SRSP 700 attempts to increase a level of similarity between the user feedback 504 and the host device 12 system 10 prompt from a first level to a second level greater than the first. In several examples, the rewriting of system 10 prompts may be carried out electronically and automatically, or as shown in the figures, the one or more human experts or validators 32 manually rewrite system 10 prompts. Subsequently, at block 710, the SRSP 700 utilizes test inputs 712 to perform a regression test on the rewritten system 10 prompt from block 708. The regression test carried out at block 710 ensures that new information in the rewritten system 10 prompt is functioning properly and that system 10 responses have not been negatively impacted by the rewritten system 10 prompt. At block 714, the SRSP 700 determines whether the newly modified system 10 prompt is performing satisfactorily, based on predetermined data such as predetermined and/or variable metrics and/or threshold values. Upon determining that performance remains unsatisfactory, the SRSP 700 returns to block 708 where the system 10 prompt is rewritten again in another attempt to more closely align the user feedback 504 to the system 10 prompt. It will be appreciated that the threshold for determining whether performance is satisfactory or unsatisfactory may be predetermined, variable, or dynamic depending on the host device 12 functions implicated by the system 10 prompt and user 16 commands 18. At block 714, upon determining that performance is satisfactory, the SRSP 700 proceeds to block 716 where the system 10 prompt is recorded in the DKB 51 or other such updated DKB 51′, including the new user 16 modified and expert 32 verified system 10 prompts. It will be appreciated that the SRSP 700 is only called upon to alter the system 10 prompts in rare situations, because the system prompts 10 are integral to LLM 36 functionality. Therefore, human expert 32 review of the SRSP 700 process is used to reduce the potential for errant data to be added to system 10 prompts in the updated DKB 51′.

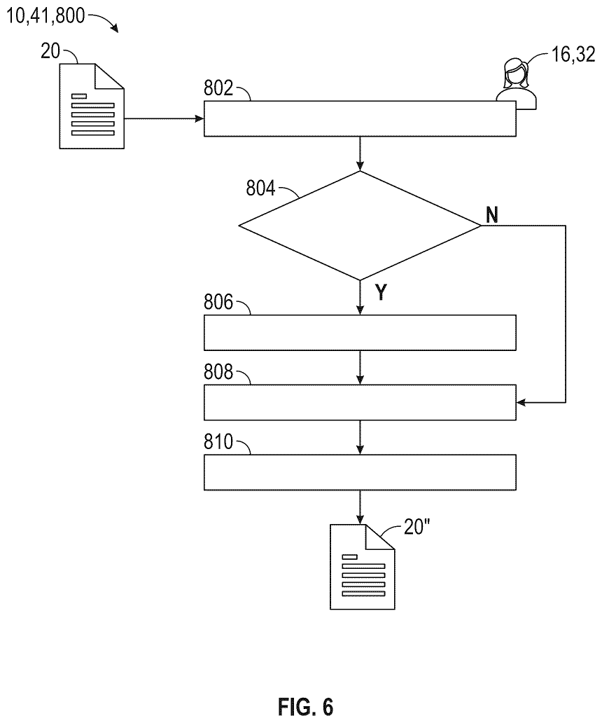

Turning now to FIG. 6, and with continuing reference to FIGS. 1-5, the SCR 800 is shown in additional detail in flowchart form. The SCR 800 regenerates contexts and/or reprioritizes existing contexts to regenerate the LLM 36 output based on user 16 feedback 504. That is, the SCR 800 reviews context from the original LLM output 20 and uses progressively smaller subsets of contexts to filter down and more accurately regenerate an LLM output 20″ that is more relevant to the input 100 or command 18 from the user 16. As depicted in FIG. 6, the SCR 800 begins at block 802 where the user 16 and/or human expert or validator 32 reviews the contexts used by the LLM 36 to generate the LLM output 20. Subsequently, at block 804, the SCR 800 determines whether a low quality context is present. As described previously with respect to the CLR application 40, “low quality” contexts define low-quality matches between the one set of data and another set of data, specifically the context used by the LLM 20 and the user 16 input 100 in a non-limiting example. Upon determining at block 804 that a low-quality context is present, the SCR 800 proceeds to block 806 where the low quality context is removed from use within the DKB 51. Subsequently, at block 808, the SCR 800 reprioritizes the contexts within the DKB 51 to account for removed low-quality contexts. Referring once more to block 804, upon determining that a low quality context does not exist, the SCR 800 proceeds directly from block 804 to block 808 where reprioritization of contexts in the DKB 51 is carried out, when necessary. Subsequently, the SCR 800 proceeds to block 810 where the SCR 800 creates a regenerated LLM output 20″ that accounts for the reprioritized contexts in the DKB 51.

In a non-limiting example of the SCR 800 in use, the user 16 input command 18 may be a command to the host device 12 or vehicle 14 to navigate to a fast food restaurant within ten miles of the user's 16 current location. The LLM 36 processes the user 16 input command 18, references various databases and/or DKBs 51 to determine what popular fast food restaurants are within a ten-mile radius of the user's 16 current location. The LLM 36 then generates an LLM output 20 including a list of a predetermined quantity of highest-ranked contexts, such as a ranked list of (i.e. locally, nationally, or internationally most popular) fast food restaurants. Based on the LLM output 20 and user 16 preferences, the user 16 may determine, as at block 802, that the LLM output 20 is insufficiently accurate or specific for the user's 16 own desires, and may request that the LLM 36 re-generate the LLM output 20 based on additional constraints, such as: user 16 preferences for ethnic food, health food, or the like. Subsequently, the SCR 800 causes the LLM 36 to create a new regenerated LLM output 20″ constrained by the user 16 preferences. That is, the SCR 800 causes the LLM 36 to regenerate the LLM output 20″ according to user feedback 504 constrained context. Accordingly, the user 16 may reprioritize the LLM outputs 20 and regenerated LLM outputs 20″ based on user 16 preferences continuously to further refine and specify LLM outputs 20. That is, the SCR 800 utilizes user feedback 504 in response to LLM outputs 20 to revise LLM outputs 20 based on user constraints.

A system 10 and UFA 41, including the performance tuning optimizer 502 of the present disclosure offer several advantages, these include providing a systematic approach to automatically determining accuracy, relevancy, and consistency of RAG tool assisted LLMs 36 that ensure LLM output 20 accuracy, precision, consistency, reliability, and which provide redundant and consistent checks to ensure the LLM output 20 accuracy, precision, consistency and reliability are maintained while maintaining or reducing system 10 complexity, and providing for user 16 feedback 504 to be received and implemented to further ensure the accuracy, relevancy, and consistency of LLM outputs 20 while efficiently prioritizing verification, and substantially reducing quantities of human effort and man-hours necessary to verify outputs 20 of the LLM 36. At the same time, the system 10 and UFA 41 of the present disclosure increase LLM 36 accuracy while reducing computational effort and computational resource consumption, and while improving computational efficiency and reducing the potential for human-introduced and/or automatically-generated typographical, syntactical, semantic or other such errors from a first quantity to a second quantity substantially less than the first quantity.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for incorporating user feedback in a large language model (LLM) based retrieval augmentation (RAG) tools, the system comprising:
a host device having a controller, the controller having a processor, a memory, and input/output (I/O) ports, the I/O ports in communication with a human-machine interface (HMI) and one or more databases, the processor executing programmatic control logic stored in the memory, the programmatic control logic including an application for incorporating user feedback (UFA) in LLM based RAG tools, the UFA comprising:
a first control logic that receives an input to the LLM from a host device user;
a second control logic that generates an LLM output as a response to the input;
a third control logic that causes a system user to verify the LLM output and provide user feedback via a human-machine interface (HMI) of the host device; and
a fourth control logic that, in response to the user feedback, engages a performance tuning optimizer that modifies the LLM output by: revising domain knowledge, revising system prompts, and performing constrained regeneration of the LLM output, wherein the performance tuning optimizer progressively reduces computational resource utilization, progressively increases computational efficiency, and progressively reduces reliance on human validators and user feedback over time, and wherein the LLM output is a command to one or more systems of the host device.

2. The system of claim 1, wherein the first control logic further comprises:
control logic for receiving the input via the human-machine interface (HMI) of the host device.

3. The system of claim 2, wherein the second control logic further comprises:
control logic for engaging an ensemble retriever, wherein the ensemble retriever that determines a similarity between the input and predetermined data in the one or more databases stored in the memory;
control logic for causing the ensemble retriever to generate the LLM output and an output confidence score;
control logic for causing a human validator to prioritize and review the LLM output in accordance with the output confidence score;
control logic for assigning the output confidence score to the LLM output, wherein the LLM output commands one or more actuators of the host device to adjust performance of relevant host device systems;
control logic that causes the human validator to prioritize and review the LLM output according to the output confidence score and a ranked context; and
causing the human validator to selectively update one or more of a text vector database and a raw text database with data obtained from the input, the LLM output, and the output confidence score, and
wherein the host device comprises a vehicle and LLM output commands to the one or more actuators of the vehicle alter functionality of the vehicle in accordance with inputs received from the user.

4. The system of claim 3, wherein the third control logic further comprises:
control logic that prompts the system user for feedback via a request for confirmation that the LLM output is a sufficiently accurate response to the input or user command, wherein the request for confirmation further comprises: an audiovisual, tactile, verbal, numerical, or alphanumeric request for confirmation, and wherein the sufficiently accurate response is gauged based upon personal preference of the user.

5. The system of claim 4, wherein the fourth control logic further comprises:
control logic for engaging a subroutine for revising domain knowledge (SRDK), wherein the SRDK receives the LLM output and the user feedback and determines whether the LLM output has been modified by the user and upon determining that the LLM output has been modified by the user, executes control logic for optimizing a domain knowledge base (DKB).

6. The system of claim 4, wherein the control logic for optimizing the DKB further comprises:
control logic that retrieves the confidence score of the LLM output that has been modified by the user, and determines whether the LLM output that has been modified by the user is already present in the DKB, wherein
upon determining that the LLM output that has been modified by the user is not already present in the DKB, obtains input from human experts to verify that the LLM output that has been modified by the user correctly added to the DKB; and
wherein upon determining that the LLM output that has been modified by the user is already present in the DKB, revises domain knowledge embedded in the DKB, thereby generating an updated DKB containing the LLM output that has been modified by the user.

7. The system of claim 4, wherein the fourth control logic further comprises:
control logic for engaging a subroutine for revising system prompts (SRSP), wherein the SRSP receives a prompt revision verification request, the LLM output, and the user feedback and determines whether sufficient evidence exists to implement revisions to system prompts, wherein in order to determine whether sufficient evidence exists, the SRSP compares a host device prompt to the user feedback and determines whether a threshold level of similarity exists between the host device prompt and the user feedback, wherein upon determining that sufficient evidence does exist, executing control logic to rewrite the system prompt, subject to performance testing.

8. The system of claim 7, wherein the control logic to rewrite the system prompt further comprises:
control logic that performs regression testing on a rewritten system prompt, wherein the regression testing utilizes test inputs stored in memory of the DKB, the regression testing verifies that new information in rewritten system prompts allow the system to continue functioning without negatively impacting system responses, and
wherein upon determining that the rewritten system prompt is functioning properly, executes control logic that updates the system prompt in the DKB, and
wherein upon determining that the rewritten system prompt is not functioning properly, continues utilizing user feedback to recursively and continuously rewrite the system prompt, regression test the rewritten system prompt and test for system functionality until the regression testing indicates that the new information allows the system to continue functioning without negatively impacting system responses.

9. The system of claim 4, wherein the fourth control logic further comprises:
control logic for executing a subroutine for constrained regeneration (SCR), wherein the SCR utilizes user feedback in response to LLM outputs to revise LLM outputs based on user constraints.

10. The system of claim 9, wherein the SCR further comprises:
control logic for reviewing context used by the LLM to generate the LLM output;
control logic for determining whether low quality context is present, wherein low quality contexts define low-quality matches between the context used by the LLM to generate the LLM output and a context of the user input, wherein low quality contexts are defined according to user preferences; and
control logic that receives user feedback via the HMI indicating that a low-quality context is present, removing the low quality context, and reprioritizing contexts before executing control logic to regenerate an LLM output subject to user feedback constrained context.

11. A method for incorporating user feedback in a large language model (LLM) based retrieval augmentation (RAG) tools, the method comprising:
executing, by a processor of a controller of a vehicle, programmatic control logic stored within memory of the controller, the controller further having input/output (I/O) ports, the I/O ports in communication with a human-machine interface (HMI) and one or more databases, the programmatic control logic including an application for incorporating user feedback (UFA) in LLM based RAG tools, the UFA comprising:
receiving an input to the LLM from a vehicle user, via the HMI of the vehicle;
generating an LLM output as a response to the input;
causing a user to verify the LLM output and provide user feedback via a human-machine interface (HMI) of vehicle; and
in response to the user feedback, engaging a performance tuning optimizer that modifies the LLM output by: revising domain knowledge, revising system prompts, and performing constrained regeneration of the LLM output, wherein the performance tuning optimizer progressively reduces computational resource utilization, progressively increases computational efficiency, and progressively reduces reliance on human validators and user feedback over time, and wherein the LLM output is a command to one or more systems of the vehicle.

12. The method of claim 11, further comprising:
engaging an ensemble retriever, wherein the ensemble retriever that determines a similarity between the input and predetermined data in the one or more databases stored in the memory;
causing the ensemble retriever to generate the LLM output and an output confidence score;
causing a human validator to prioritize and review the LLM output in accordance with the output confidence score;
assigning the output confidence score to the LLM output, wherein the LLM output commands one or more actuators of the vehicle to adjust performance of relevant vehicle systems;
causing the human validator to prioritize and review the LLM output according to the output confidence score and a ranked context; and
causing the human validator to selectively update one or more of a text vector database and a raw text database with data obtained from the input, the LLM output, and the output confidence score, and
wherein LLM output commands to the one or more actuators of the vehicle alter functionality of the vehicle in accordance with inputs received from the user.

13. The method of claim 12, further comprising:
prompting the user for feedback via a request for confirmation that the LLM output is a sufficiently accurate response to the input or user command, wherein the request for confirmation further comprises: an audiovisual, tactile, verbal, numerical, or alphanumeric request for confirmation, and wherein the sufficiently accurate response is gauged based upon personal preference of the user.

14. The method of claim 13, further comprising:
engaging a subroutine for revising domain knowledge (SRDK), wherein the SRDK receives the LLM output and the user feedback and determines whether the LLM output has been modified by the user and upon determining that the LLM output has been modified by the user, executes control logic for optimizing a domain knowledge base (DKB).

15. The method of claim 14, wherein optimizing the DKB further comprises:
retrieving the confidence score of the LLM output that has been modified by the user, and determines whether the LLM output that has been modified by the user is already present in the DKB, wherein
upon determining that the LLM output that has been modified by the user is not already present in the DKB, obtaining input from human experts to verify that the LLM output that has been modified by the user correctly added to the DKB; and
wherein upon determining that the LLM output that has been modified by the user is already present in the DKB, revising domain knowledge embedded in the DKB, thereby generating an updated DKB containing the LLM output that has been modified by the user.

16. The method of claim 14, further comprising:
engaging a subroutine for revising system prompts (SRSP), wherein the SRSP receives a prompt revision verification request, the LLM output, and the user feedback and determines whether sufficient evidence exists to implement revisions to system prompts;
determining whether sufficient evidence exists by comparing, with the SRSP, a vehicle prompt to the user feedback; and
determining whether a threshold level of similarity exists between the vehicle prompt and the user feedback, wherein upon determining that sufficient evidence does exist, rewriting the system prompt, subject to performance testing.

17. The method of claim 16, wherein rewriting the system prompt further comprises:
performing regression testing on a rewritten system prompt, wherein the regression testing utilizes test inputs stored in memory of the DKB, the regression testing verifies that new information in rewritten system prompts allow the vehicle to continue functioning without negatively impacting vehicle responses, and
wherein upon determining that the rewritten system prompt is functioning properly, executes control logic that updates the system prompt in the DKB, and
wherein upon determining that the rewritten system prompt is not functioning properly, continues utilizing user feedback to recursively and continuously rewrite the system prompt, regression test the rewritten system prompt and test for vehicle functionality until the regression testing indicates that the new information allows the vehicle to continue functioning without negatively impacting system responses.

18. The method of claim 14, further comprising:
executing a subroutine for constrained regeneration (SCR), wherein the SCR utilizes user feedback in response to LLM outputs to revise LLM outputs based on user constraints.

19. The method of claim 18, wherein the SCR further comprises control logic for:
reviewing context used by the LLM to generate the LLM output;
determining whether low quality context is present, wherein low quality contexts define low-quality matches between the context used by the LLM to generate the LLM output and a context of the user input, wherein low quality contexts are defined according to user preferences; and
receiving user feedback via the HMI indicating that a low-quality context is present, removing the low quality context, and reprioritizing contexts before executing control logic to regenerate an LLM output subject to user feedback constrained context.

20. A method for incorporating user feedback in a large language model (LLM) based retrieval augmentation (RAG) tools, the method comprising:
executing, by a processor of a controller of a vehicle, programmatic control logic stored within memory of the controller, the controller further having input/output (I/O) ports, the I/O ports in communication with a human-machine interface (HMI) and one or more databases, the programmatic control logic including an application for incorporating user feedback (UFA) in LLM based RAG tools, the UFA comprising:
receiving an input to the LLM from a vehicle user, via the HMI of the vehicle;
generating an LLM output as a response to the input, including:
engaging an ensemble retriever, wherein the ensemble retriever that determines a similarity between the input and predetermined data in the one or more databases stored in the memory;
causing the ensemble retriever to generate the LLM output and an output confidence score;
causing a human validator to prioritize and review the LLM output in accordance with the output confidence score;
assigning the output confidence score to the LLM output, wherein the LLM output commands one or more actuators of the vehicle to adjust performance of relevant vehicle systems;
causing the human validator to prioritize and review the LLM output according to the output confidence score and a ranked context; and
causing the human validator to selectively update one or more of a text vector database and a raw text database with data obtained from the input, the LLM output, and the output confidence score, and
wherein LLM output commands to the one or more actuators of the vehicle alter functionality of the vehicle in accordance with inputs received from the user;
causing a user to verify the LLM output and prompting the user for feedback via the HMI of the vehicle, including providing a request for confirmation that the LLM output is a sufficiently accurate response to the input or user command, wherein the request for confirmation further comprises: an audiovisual, tactile, verbal, numerical, or alphanumeric request for confirmation, and wherein the sufficiently accurate response is gauged based upon personal preference of the user; and in response to the user feedback, engaging a performance tuning optimizer that modifies the LLM output by:
revising domain knowledge comprising:
engaging a subroutine for revising domain knowledge (SRDK), wherein the SRDK receives the LLM output and the user feedback and determines whether the LLM output has been modified by the user and upon determining that the LLM output has been modified by the user, executes control logic for optimizing a domain knowledge base (DKB);
retrieving the confidence score of the LLM output that has been modified by the user, and determines whether the LLM output that has been modified by the user is already present in the DKB, wherein
upon determining that the LLM output that has been modified by the user is not already present in the DKB, obtaining input from human experts to verify that the LLM output that has been modified by the user correctly added to the DKB; and
wherein upon determining that the LLM output that has been modified by the user is already present in the DKB, revising domain knowledge embedded in the DKB, thereby generating an updated DKB containing the LLM output that has been modified by the user;
revising system prompts, including:
engaging a subroutine for revising system prompts (SRSP), wherein the SRSP receives a prompt revision verification request, the LLM output, and the user feedback and determines whether sufficient evidence exists to implement revisions to system prompts;
determining whether sufficient evidence exists by comparing, with the SRSP a vehicle prompt to the user feedback; and
determining whether a threshold level of similarity exists between the vehicle prompt and the user feedback, wherein upon determining that sufficient evidence does exist, rewriting the system prompt, subject to performance testing;
performing regression testing on a rewritten system prompt, wherein the regression testing utilizes test inputs stored in memory of the DKB, the regression testing verifies that new information in rewritten system prompts allow the vehicle to continue functioning without negatively impacting vehicle responses, and
wherein upon determining that the rewritten system prompt is functioning properly, executes control logic that updates the system prompt in the DKB, and
wherein upon determining that the rewritten system prompt is not functioning properly, continues utilizing user feedback to recursively and continuously rewrite the system prompt, regression test the rewritten system prompt and test for vehicle functionality until the regression testing indicates that the new information allows the vehicle to continue functioning without negatively impacting system responses; and
performing constrained regeneration of the LLM output, including:
executing a subroutine for constrained regeneration (SCR), wherein the SCR utilizes user feedback in response to LLM outputs to revise LLM outputs based on user constraints;
reviewing context used by the LLM to generate the LLM output;
determining whether low quality context is present, wherein low quality contexts define low-quality matches between the context used by the LLM to generate the LLM output and a context of the user input, wherein low quality contexts are defined according to user preferences; and
receiving user feedback via the HMI indicating that a low-quality context is present, removing the low quality context, and reprioritizing contexts before executing control logic to regenerate an LLM output subject to user feedback constrained context,
wherein the performance tuning optimizer progressively reduces computational resource utilization, progressively increases computational efficiency, and progressively reduces reliance on human validators and user feedback over time, and wherein the LLM output is a command to one or more systems of the vehicle.
